(19) United States
(12) Patent Application Publication
(10) Pub. No.: US 2018/0291761 A1
(43) Pub. Date: Oct. 11, 2018

(54) ENERGY GENERATING SYSTEM AND METHOD

(71) Applicant: HYDROSPIN MONITORING SOLUTIONS LTD., Netanya (IL)

(72) Inventor: Dani Peleg, Kiryat Tivon (IL)

(21) Appl. No.: 15/575,724

(22) PCT Filed: May 26, 2016
(86) PCT No.: PCT/IL2016/050550

§ 371 Date: Nov. 20, 2017

Related U.S. Application Data
(60) Provisional application No. 62/166,709, filed on May 27, 2015.

(51) Int. Cl. F01D 17/14; F01D 17/10; F01D 15/10; F01D 1/04

(52) U.S. Cl. CPC F01D 17/148; F01D 17/105; F05D 2220/76; F01D 1/04; F05D 2240/55; F01D 15/10

(57) ABSTRACT

An energy generating system for transforming energy of fluid flow into electric energy, the system, at least in operation, comprising: a flow-changing member having a peripheral rim and mounted in a fluid path having a path surface, so as to be at least partially surrounded by said path surface, said flow-changing member being displaceable between a first position, in which at least a portion of the rim is spaced from a corresponding portion of the path surface to a first extent and a second position, in which said portion of the rim is spaced from said portion of the fluid path surface to a second extent greater than said first extent, so that increase of total volumetric flow rate of said fluid above a predetermined threshold to an increased volumetric flow rate is configured to induce displacement of said flow-changing member from said first position toward said second position, thereby causing the volumetric flow rate of said fluid at said spacing to be above said increased volumetric flow rate; and a turbine mounted in fluid communication with said fluid path at a location other than said spacing, whereby said displacement causes the volumetric flow rate of said fluid at said turbine to be below said increased volumetric flow rate.

### TECHNOLOGICAL FIELD

This presently disclosed subject matter relates to the field of energy generating systems, and more particularly to energy generating systems using turbines disposed in a fluid line.

### BACKGROUND

Electric power generators and turbines driven by fluid flowing under pressure in pipes are known, for example, from U.S. Pat. Nos. 6,011,334, 6,526,907 and 6,848,503, disclosing rotational drive means disposed inside the pipes axially along the direction of flow.

In particular, U.S. Pat. No. 6,011,334 discloses an electric power generator driven by a fluid circulating under pressure in a pipe and including an internal moving contact placed inside a non-magnetic section of the pipe, and a stator placed around the pipe. The electric power generator can be used in gas and liquid transport networks. U.S. Pat. No. 6,526,907 discloses a flow indicating a device including a tube, a turbine wheel, and a cylinder. The tube defines a flow path. The turbine wheel is mounted in the tube for rotation alongside an inside wall of the tube. The turbine wheel has a plurality of turbine blades. The cylinder is mounted outside the tube for rotation alongside an outside wall of the tube. The cylinder is magnetically coupled to the turbine wheel through the sidewall of the tube so that rotation of the turbine wheel causes rotation of the cylinder. U.S. Pat. No. 6,848,503 discloses a power generating system for a downhole operation having production tubing in a wellbore which includes a magnetized rotation member coupled to the wellbore within the production tubing.

### GENERAL DESCRIPTION

According to a first aspect of the presently disclosed subject matter, there is provided an energy generating system for transforming energy of fluid flow into electric energy, the system, at least in operation, comprising:

a flow-changing member having a peripheral rim and mounted in a fluid path having a path surface, so as to be at least partially surrounded by said path surface, said flow-changing member being displaceable between a first position, in which at least a portion of the rim is spaced from a corresponding portion of the path surface to a first extent and a second position, in which said portion of the rim is spaced from said portion of the fluid path surface to a second extent greater than said first extent, so that increase of total volumetric flow rate of said fluid above a predetermined threshold to an increased volumetric flow rate is configured to induce displacement of said flow-changing member from said first position toward said second position, thereby causing the volumetric flow rate of said fluid at said spacing to be above said increased volumetric flow rate; and

a turbine mounted in fluid communication with said fluid path at a location other than said spacing, whereby said displacement causes the volumetric flow rate of said fluid at said turbine to be below said increased volumetric flow rate.

According to a second aspect of the presently disclosed subject matter, there is provided an energy generating system for transforming energy of fluid flow into electric energy, the system comprising:

a flow-changing member having a peripheral rim and configured for being positioned in a fluid path having a flow direction and a path surface so as to be at least partially surrounded by said surface, said flow-changing member being displaceable between a first position, in which projection of the flow-changing member on a reference plane taken perpendicularly to said flow direction forms a first area, and a second position, in which projection of said flow-changing member on said reference plane forms a second area smaller than said first area by at least a first difference area formed outside said second area; and

a turbine configured to be mounted in fluid communication with said fluid path at a location other than said first difference area.

According to a third aspect of the presently disclosed subject matter, there is provided a method for using an energy generating system for transforming energy of fluid flow into electric energy, the system, at least in operation, comprising: a flow-changing member having a peripheral rim and mounted in a fluid path having a path surface, so as to be at least partially surrounded by said path surface, said flow-changing member being displaceable between a first position, in which at least a portion of the rim is spaced from a corresponding portion of the path surface to a first extent and a second position, in which said portion of the rim is spaced from said portion of the fluid path surface to a second extent greater than said first extent; and a turbine mounted in said fluid path at a location other than said spacing, comprising steps of:
a. experiencing increase of total volumetric flow rate of said fluid above a predetermined threshold to an increased volumetric flow rate; and
b. inducing displacement of said flow-changing member from said first position to said second position, thereby causing the volumetric flow rate of said fluid at said spacing to be above said increased volumetric flow rate and causing the volumetric flow rate of said fluid at said turbine to be below said increased volumetric flow rate.

The term ‘fluid path’ refers hereinafter in the specification and the claims to a body in the form of at least one pipe, at least one tube, at least one conduit, at least one duct, at least one canal, at least one channel, at least one vessel, at least one hose, at least one tank, or at least one container in which fluid (e.g., gas or liquid) is able to flow under a predetermined pressure and at a predetermined volumetric flow rate.

The term ‘turbine’ refers hereinafter in the specification and the claims to a rotary mechanical device that extracts energy from a fluid flow and converts it into electric energy by rotation of at least one rotor with respect to at least one stator, constituting together an energy generator.

The system and the method according to the first, the second and the third aspect of the presently disclosed subject matter are configured to protect overheating a turbine when the total volumetric flow rate of fluid is increased above a predetermined threshold to an increased volumetric flow rate at which such overheating may occur as a result of the increase which causes the rotor of the turbine to be rotated at a very high speed. This fast rotation of the rotor may even result in burning out of the generator. The protection of the generator is thus performed by increasing the cross-sectional area of the fluid path at a location other than the turbine, so that the volumetric flow rate of the fluid passing through the turbine is less than the increased volumetric flow rate. In particular, when the flow-changing member is disposed in its first position, it constitutes disturbance along the fluid path. However, when the total volumetric flow rate is increased above the predetermined threshold, the flow-changing member is displaced from its first position toward its second position, thereby forming therebetween spacing and at least the first difference area. This displacement decreased the effective disturbance to passage of fluid between the flow-changing member and the path surface, allowing part of the fluid to pass via the spacing and the respective first difference area formed between the flow-changing member and the path surface, instead of through said turbine, which in turn reduces the volumetric flow rate of the fluid passing via the turbine to be lower than the increased volumetric flow rate. By that, the turbine is subject to less volumetric flow rate of the fluid passing therethrough, when compared to a situation in which the flow-changing member is not displaced from its first position. According to some examples of the presently disclosed subject matter, the displacement of the flow-changing member may also involve at least partial diversion or tilting of the turbine from the flow path.

The definitions of the spacing formed between the flow-changing member and the path surface by the first extent and the second extent (according to the first aspect) and by the first difference area (according to the second aspect) can be considered as alternative definitions.

The flow-changing member can be configured to be displaced from the first position to the second position by force of the fluid applied thereon. This force can be applied in the flow direction of the fluid in the fluid path.

The system can further comprise a spring engaging the flow-changing member for urging the flow-changing member to revert to its first position.

The system can further comprise a compression-regulating mechanism configured for regulating compression of said spring. This regulation can determine said predetermined threshold.

Decrease of the total volumetric flow rate of the fluid from the increased volumetric flow rate can be configured to induce displacement of the flow-changing member toward the first position.

The flow-changing member can be pivotally mounted to the path surface for pivotal displacement thereof from the first position toward the second position in a flow direction of the fluid. According to another example, the flow-changing member can be part of a wafer check valve.

In the first position, the flow-changing member can be configured to be disposed perpendicularly to flow direction of the fluid flowing at the path surface and in the second position, the flow-changing member can be configured to be angled with respect to the flow direction.

The path surface can comprise a socket for receiving the flow-changing member in the second position.

The flow-changing member can comprise a sealing end configured for sealingly engaging a sealing portion of the path surface in the first position of the flow-changing member, thereby preventing passage of fluid therebetween.

The system can further comprise the fluid path.

The fluid path comprises a path inlet and a path outlet with the path surface extending therebetween.

The path surface can have an cross-sectional diameter that changes along its length, for example, as provided in a wafer check valve.

The system can further comprise an additional fluid path which is in fluid communication with the fluid path and in which the turbine is mounted.

The additional fluid path can extend between a sub-inlet and a sub-outlet, both formed at the path surface so that the flow-changing member is mounted in the fluid path therebetween.

The turbine can be integrated in the flow-changing member and displaceable therewith between the first position and the second position. In this case, upon displacement of the flow-changing member from the first direction to the second direction, the turbine is diverted from the flow path together with the flow-changing member.

The turbine can be concentric with the flow-changing member.

In the first position, projection of the turbine on the reference plane can form a third area, and in the second position, projection of the turbine on the reference plane can form a fourth area smaller than the third area by at least a second difference area formed outside the third area. Such second difference area causes less fluid to enter into the turbine in the second position of the flow-changing member, thereby causing the total volumetric flow rate at the turbine to be less than the increased volumetric flow rate which is above the predetermined threshold, and protecting the turbine from overheating.

The step of inducing displacement can be performed by virtue of force applied by the fluid on the flow-changing member.

The method can further comprise steps of decreasing total volumetric flow rate of the fluid from the increased volumetric flow rate; and inducing displacement of the flow-changing member toward the first position.

### BRIEF DESCRIPTION OF THE DRAWINGS

In order to better understand the subject matter that is disclosed herein and to exemplify how it may be carried out in practice, embodiments will now be described, by way of non-limiting examples only with reference to the accompanying drawings, in which:

FIG. 1A is an isometric view of a system in accordance with a first example of the presently disclosed subject matter, in which the flow-changing member of the system is in its first position;

FIG. 1B is a cross-sectional view along line A-A in FIG. 1A;

FIG. 2A is an isometric view of the system according to the example of FIG. 1A, in which the flow-changing member of the system is in its second position;

FIG. 2B is a cross-sectional view along line B-B in FIG. 2A;

FIG. 3A is an isometric view of a system in accordance with a second example of the presently disclosed subject matter, in which the flow-changing member of the system is in its first position;

FIG. 3B is a cross-sectional view along line C-C in FIG. 3A;

FIG. 4A is an isometric view of the system according to the example of FIG. 3A, in which the flow-changing member of the system is in its second position;

FIG. 4B is a cross-sectional view along line D-D in FIG. 4A;

FIG. 5A is a front isometric view of a system in accordance with a third example of the presently disclosed subject matter, in which the flow-changing member of the system is in its first position;

FIG. 5B illustrates a rear isometric view of the system of FIG. 5A;

FIG. 5C illustrates a rear view of the system of FIG. 5A;

FIG. 5D is a cross-sectional view along line E-E in FIG. 5A;

FIG. 5E is a cross-sectional view along line F-F in FIG. 5A;

FIG. 5F is a cross-sectional view along line G-G in FIG. 5A;

FIG. 5G is a cross-sectional view along line H-H in FIG. 5A;

FIG. 6A is a front isometric view of the system according to the example of FIG. 5A, in which the flow-changing member of the system is in its second position;

FIG. 6B illustrates a rear isometric view of the system of FIG. 6A;

FIG. 6C illustrates a rear view of the system of FIG. 6A;

FIG. 6D is a cross-sectional view along line I-I in FIG. 6A; and

FIG. 6E is a cross-sectional view along line J-J in FIG. 6A.

### DETAILED DESCRIPTION OF EMBODIMENTS

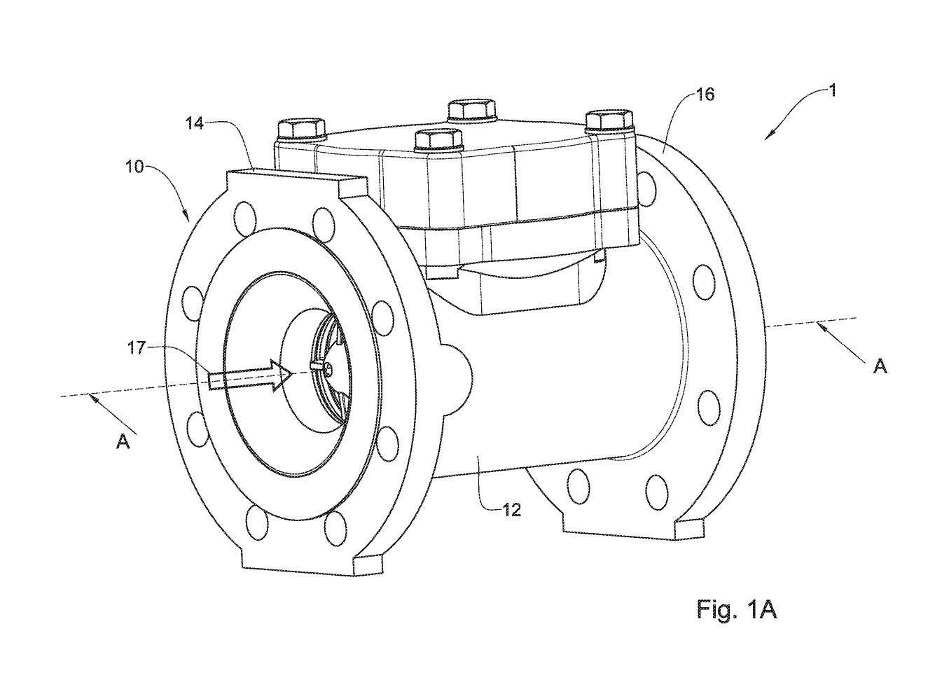

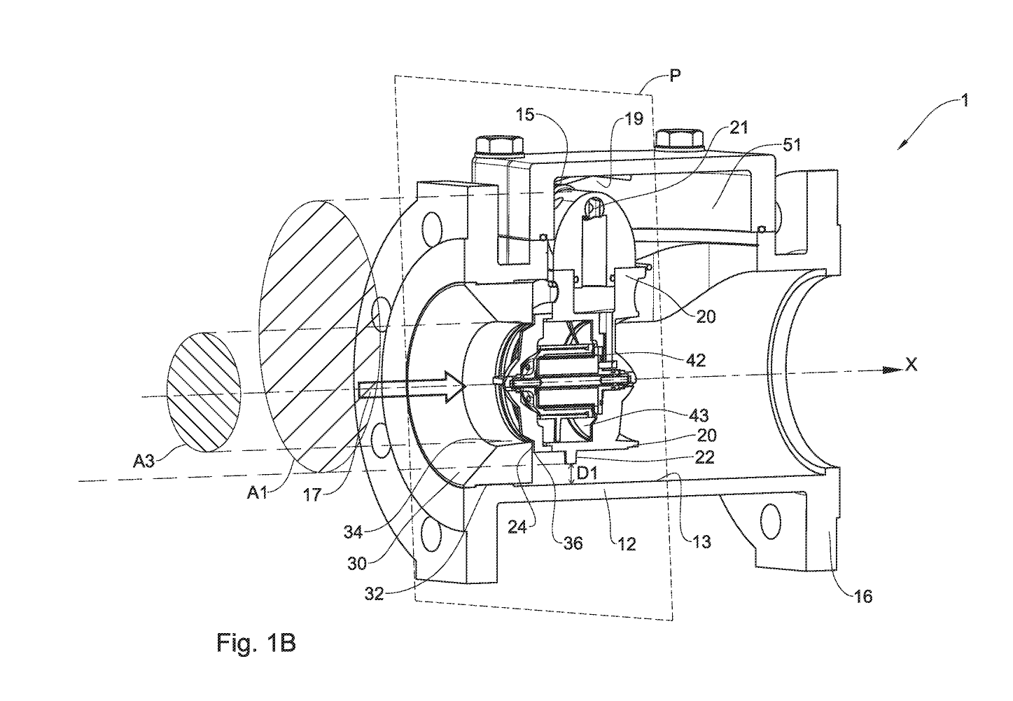

Attention is first directed to FIGS. 1A-B and 2A-B, illustrating an energy generating system 1 for transforming energy of fluid flow into electric energy, in accordance with a first example of the presently disclosed subject matter.

The system 1 has a fluid path 10 formed as a pipe having an elongate housing 12 with a path surface 13 extending between an inlet flange 14 and an outlet flange 16. The system 1 is configured to be disposed in a fluid line (not shown) by connecting the inlet flange 14 and the outlet flange 16 to respective portions of the fluid line for allowing passage of fluid 17 therethrough in a flow direction X.

In addition, the system 1 is configured with a flow-changing member 20 having a peripheral rim 22 and a turbine 40 concentrically integrated in the flow-changing member 20. The flow-changing member 20 is pivotally mounted to an interior portion 19 of the housing 12 by a pivot 21 and is surrounded by the path surface 13. The housing is provided with a sealing ring 30 disposed therein so that an external surface 32 thereof is tightly engaging the path surface 13, and an internal surface 34 thereof forms a passage for the fluid 17.

The turbine 40 has a rotor 42 with a plurality of vanes 43. The rotor 42 is rotatable within the turbine when the fluid 17 passes therethrough, and respectively generates an electric energy.

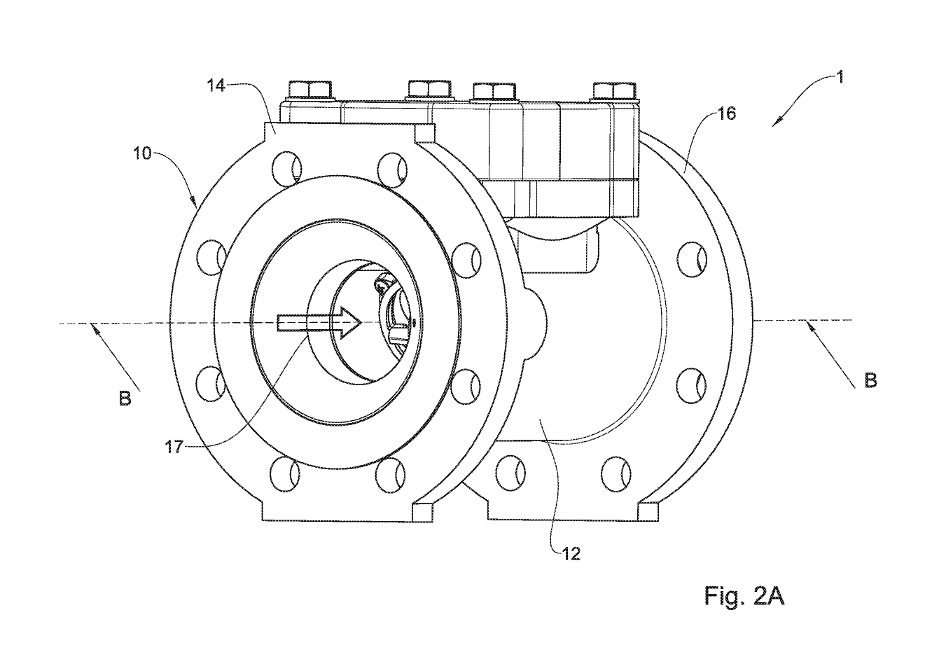

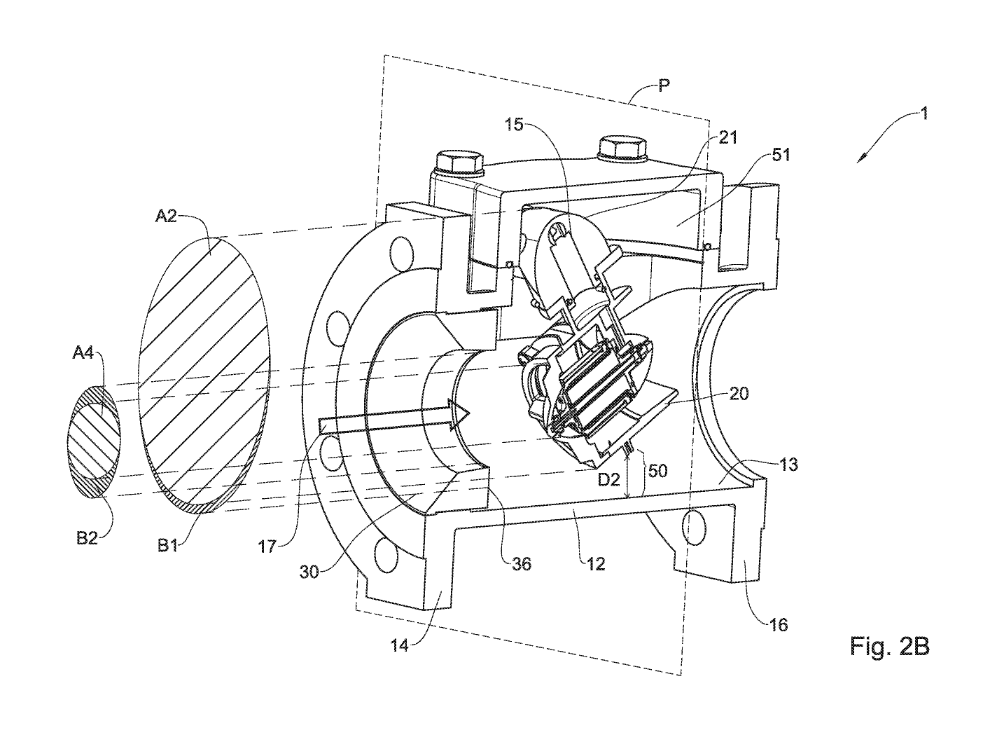

The flow-changing member 20 is displaceable between a first position shown in FIGS. 1A-B, in which the flow-changing member 20 is disposed perpendicularly to flow direction X, and a second position shown in FIGS. 2A-B, in which the flow-changing member 20 is angled together with the turbine 40 with respect to the flow direction X. Each one of these positions is explained in detail below. It is appreciated that the second position shown in FIGS. 2A-B is only an example of such position, so that according to other examples of the second position, the angle between the flow-changing member 20 and the flow axis X can be much greater.

In the first position, the rim 22 is spaced from the path surface 13 to a first distance D1. The system 1 has a reference plane P taken perpendicularly to the flow direction X, so that in the first position, projection of the flow-changing member 20 on the reference plane P forms a first area A1 (both shown in FIG. 1B). In addition, in the first position, projection of the turbine 40 on the reference plane P forms a third area A3. In the first position, a sealing end 24 of the flow-changing member 20 is sealingly engaging a rear wall 36 of the sealing ring 30, so that the fluid 17 is able to pass only via the turbine 40. This structure allows maximally exploiting the flow energy of the fluid 17 for generation of electric energy by the turbine 40.

In the second position, the rim 22 is spaced from the path surface 13 to a second distance D2, which is greater than the first distance D1, forming a spacing 50 between the rim 22 and the path surface 13 for passage of the fluid 17 also therethrough (in addition to the turbine 40). In addition, in the second position, projection of the flow-changing member 20 on the reference plane P forms a second area A2 (both shown in FIG. 2B). The second area A2 is smaller than the first area A1 by at least a first difference area B1 formed outside the second area A2. In addition, in the second position, projection of the turbine 40 on the reference plane P forms a fourth area A4 smaller than the third area A3 by at least a second difference area B2 formed outside the third area A3. The second difference area B2 causes less fluid to enter into the turbine 40 in the second position of the flow-changing member 20. In the second position, the sealing end 24 is disengaged from the rear wall 36 of the sealing ring 30, so that the fluid 17 is able to pass via the turbine 40 and via the spacing 50.

The path surface 13 is configured with a socket 51 for partially receiving the flow-changing member 20 in its second position.

The fluid path 10 is further configured with a torsion spring 15 engaging the flow-changing member 20 for urging the flow-changing member 20 to be in its normal first position.

When the total volumetric flow rate of the fluid 17 is below a predetermined threshold, the flow-changing member 20 is disposed in its first position. In this position, the force applied by the fluid 17 on the flow-changing member 20 is lower than the counter force applied on the flow-changing member 20 by the torsion spring 15, thereby preventing displacement of the flow-changing member 20 from the first position. This means that the predetermined threshold is determined by the torsion spring 15.

However, when the total volumetric flow rate of the fluid 17 is increased above the predetermined threshold to an increased volumetric flow rate, the force applied by the fluid 17 on the flow-changing member 20 is greater than the counter force applied on the flow-changing member 20 by the torsion spring 15, thereby pushing the flow-changing member 20 in the flow direction X and inducing its displacement toward the second position.

That displacement of the flow-changing member 20 causes the volumetric flow rate of the fluid 17 at the spacing 50 to be above the increased volumetric flow rate and the volumetric flow rate of the fluid 17 at the turbine 40 to be below the increased volumetric flow rate.

Such operation of the flow-changing member 20 is intended to protect the turbine 40 from overheating, or even burning out, when the total volumetric flow rate of fluid is increased above the predetermined threshold. As can be understood from the above explanation, when the flow-changing member 20 is disposed in its first position, it constitutes disturbance along the fluid path 10. However, when the total volumetric flow rate is increased above the predetermined threshold, flow-changing member 20 is displaced from its first position toward its second position, thereby forming therebetween spacing and at least the first difference area B1. This displacement decreased the effective disturbance to passage of fluid between the flow-changing member 20 and the path surface 13, allowing part of the fluid to pass via the spacing and at least the first difference area B1, instead of through the turbine 40. By that, the turbine 40 is subject to less volumetric flow rate of the fluid passing therethrough, when compared to a situation in which the flow-changing member 20 is not displaced from its first position.

In accordance with the above description, it is understood that when the total volumetric flow rate is decreased below the predetermined threshold, the flow-changing member 20 is displaced back to its first position. This displacement is performed by operation of the torsion spring 15 on the flow-changing member 20, since the force applied by the fluid 17 on the flow-changing member 20 is lower than the counter force applied by the torsion spring 15 thereon.

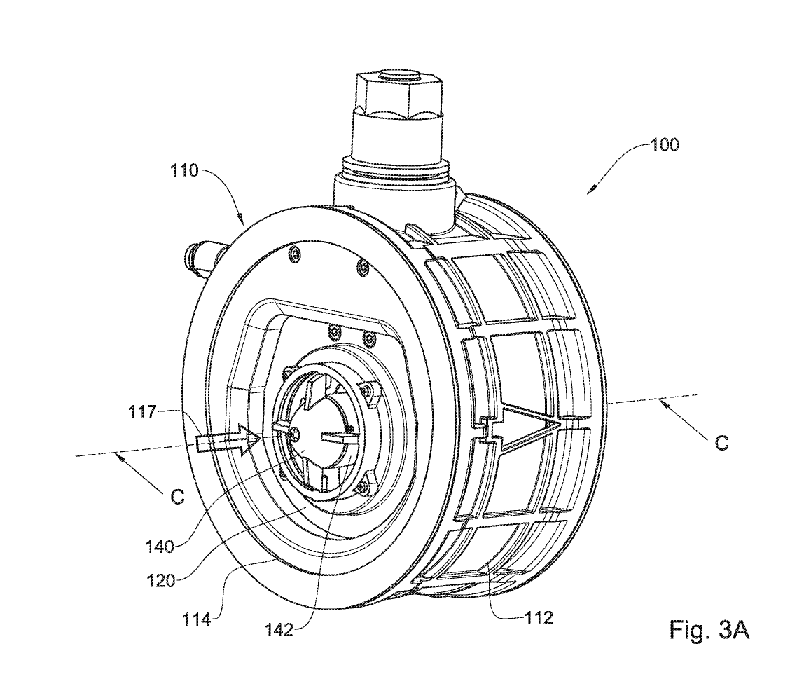

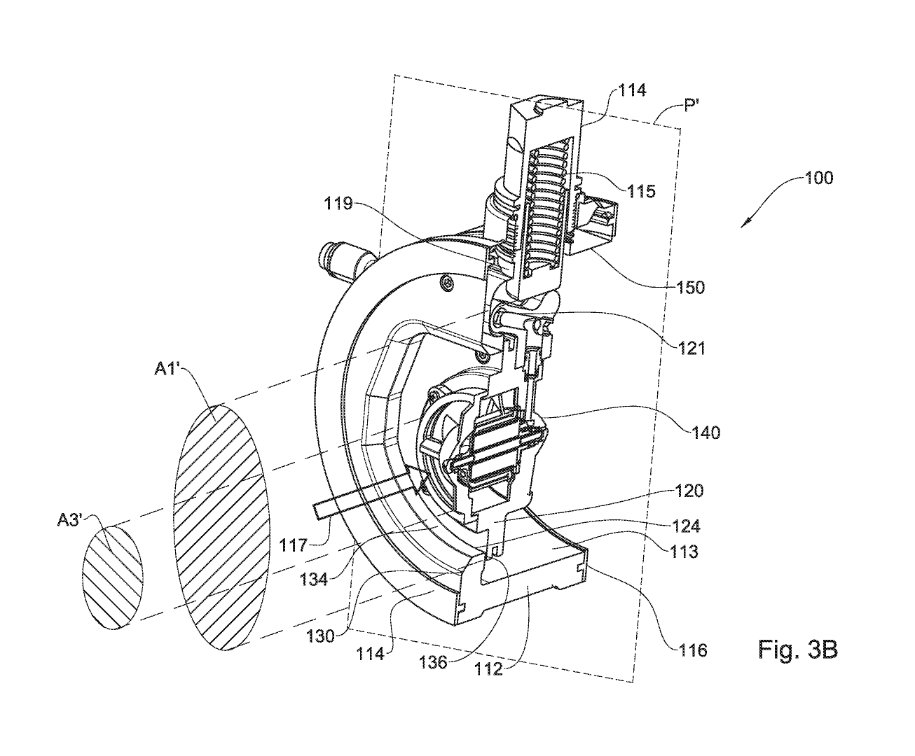

Attention is now directed to FIGS. 3A-B and 4A-B, illustrating an energy generating system 100 for transforming energy of fluid flow into electric energy, in accordance with a second example of the presently disclosed subject matter.

The system 100 has a fluid path 110 formed as a pipe having an elongate housing 112 with a path surface 113 extending between an inlet 114 and an outlet 116. The system 100 is configured to be disposed in a fluid line (not shown) by connecting the inlet 114 and the outlet 116 to respective portions of the fluid line for allowing passage of fluid 117 therethrough in a flow direction X′.

In addition, the system 100 is configured with a flow-changing member 120 having a peripheral rim 122 and a turbine 140 concentrically integrated in the flow-changing member 120. The flow-changing member 120 is pivotally mounted to an interior portion 119 of the housing 112 by a pivot 121 and is surrounded by the path surface 113. The housing 112 is provided with a sealing portion 130 extending from the path surface 113 and disposed in proximity to the inlet 114. An internal surface 134 of the sealing portion 130 forms a passage for the fluid 117.

The turbine 140 has a rotor 142 with a plurality of vanes 143. The rotor 142 is rotatable within the turbine when the fluid 117 passes therethrough, and respectively generates an electric energy.

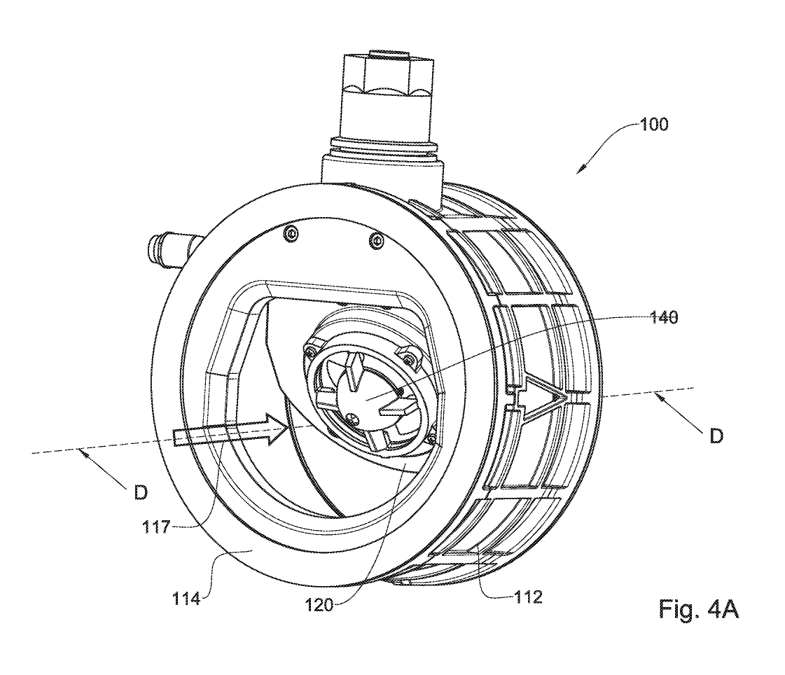

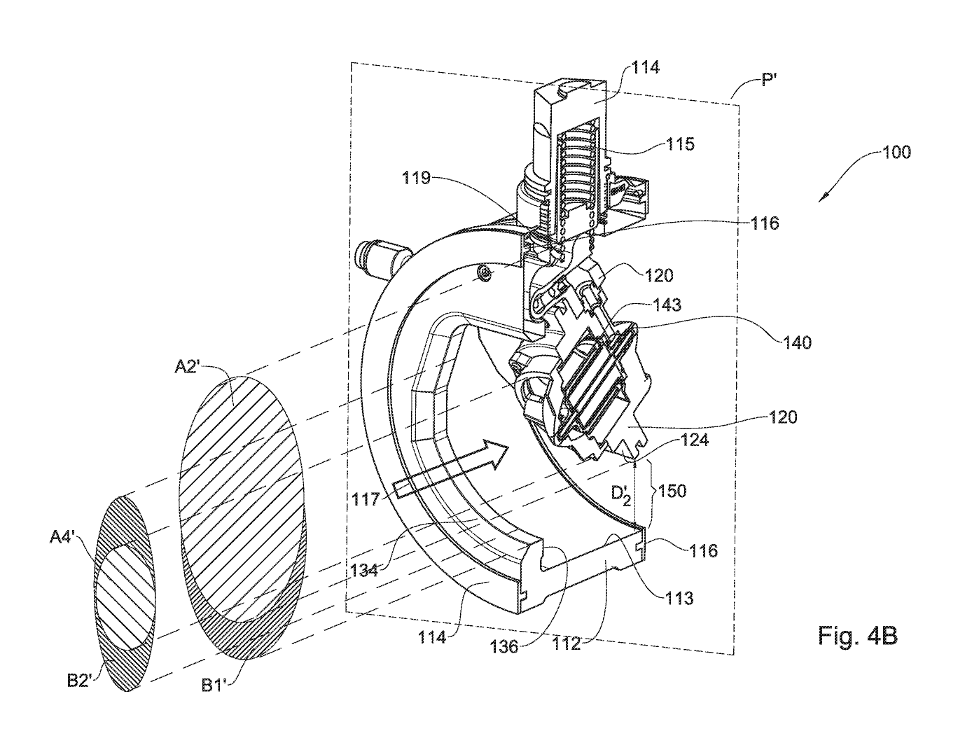

The flow-changing member 120 is displaceable between a first position shown in FIGS. 2A-B, in which the flow-changing member 120 is disposed perpendicularly to flow direction X′, and a second position shown in FIGS. 4A-B, in which the flow-changing member 120 is angled together with the turbine 140 with respect to the flow direction X′. Each one of these positions is explained in detail below. It is appreciated that the second position shown in FIGS. 4A-B is only an example of such position, so that according to other examples of the second position, the angle between the flow-changing member 120 and the flow axis X′ can be much greater.

In the first position, the rim 122 is spaced from the path surface 113 to a first distance D1′. The system 100 has a reference plane P′ taken perpendicularly to the flow direction X′, so that in the first position, projection of the flow-changing member 120 on the reference plane P′ forms a first area A1′ (both shown in FIG. 3B). In addition, in the first position, projection of the turbine 140 on the reference plane P′ forms a third area A3′. In the first position, a sealing end 124 of the flow-changing member 120 is sealingly engaging a rear wall 136 of the sealing portion 130, so that the fluid 117 is able to pass only via the turbine 140. This structure allows maximally exploiting the flow energy of the fluid 117 for generation of electric energy by the turbine 140.

In the second position, the rim 122 is spaced from the path surface 113 to a second distance D2′, which is greater than the first distance D1′, forming a spacing 150 between the rim 122 and the path surface 113 for passage of the fluid 117 also therethrough (in addition to the turbine 140). In addition, in the second position, projection of the flow-changing member 120 on the reference plane P′ forms a second area A2′ (both shown in FIG. 4B). The second area A2′ is smaller than the first area A1′ by at least a first difference area B1′ formed outside the second area A2′. In addition, in the second position, projection of the turbine 140 on the reference plane P′ forms a fourth area A4′ smaller than the third area A3′ by at least a second difference area B2′ formed outside the third area A3′. The second difference area B2′ causes less fluid to enter into the turbine 140 in the second position of the flow-changing member 120. In the second position, the sealing end 124 is disengaged from the rear wall 136 of the sealing portion 130, so that the fluid 117 is able to pass via the turbine 140 and via the spacing 150.

The path surface 113 is configured with a socket 150 for partially receiving the flow-changing member 120 in its second position.

The fluid path 110 is further configured with a compression spring 115 engaging an extension member 127 of the flow-changing member 120 for urging the flow-changing member 120 to be in its normal first position.

When the total volumetric flow rate of the fluid 117 is below a predetermined threshold, the flow-changing member 120 is disposed in its first position. In this position, the force applied by the fluid 117 on the flow-changing member 120 is lower than the counter force applied on extension member 127 of the flow-changing member 120 by the compression spring 115, thereby preventing displacement of the flow-changing member 120 from the first position. This means that the predetermined threshold is determined by the compression spring 115. The compression spring 115 constitutes a portion of a compression-regulating mechanism 114 configured for regulating compression of the compression spring 116 by regulating its length. This regulation can determine said predetermined threshold.

However, when the total volumetric flow rate of the fluid 117 is increased above the predetermined threshold to an increased volumetric flow rate, the force applied by the fluid 117 on the flow-changing member 120 is greater than the counter force applied on the flow-changing member 120 by the compression spring 115, thereby pushing the flow-changing member 120 in the flow direction X′ and inducing its displacement toward the second position.

That displacement of the flow-changing member 120 causes the volumetric flow rate of the fluid 117 at the spacing 150 to be above the increased volumetric flow rate and the volumetric flow rate of the fluid 117 at the turbine 140 to be below the increased volumetric flow rate.

Such operation of the flow-changing member 120 is intended to protect the turbine 140 from overheating, or even burning out, when the total volumetric flow rate of fluid is increased above the predetermined threshold. As can be understood from the above explanation, when the flow-changing member 120 is disposed in its first position, it constitutes disturbance along the fluid path 110. However, when the total volumetric flow rate is increased above the predetermined threshold, flow-changing member 120 is displaced from its first position toward its second position, thereby forming therebetween spacing and at least the first difference area B1′. This displacement decreased the effective disturbance to passage of fluid between the flow-changing member 120 and the path surface 113, allowing part of the fluid to pass via the spacing and at least the first difference area B1′, instead of through the turbine 140. By that, the turbine 140 is subject to less volumetric flow rate of the fluid passing therethrough, when compared to a situation in which the flow-changing member 120 is not displaced from its first position.

In accordance with the above description, it is understood that when the total volumetric flow rate is decreased below the predetermined threshold, the flow-changing member 120 is displaced back to its first position. This displacement is performed by operation of the compression spring 115 on the flow-changing member 120, since the force applied by the fluid 117 on the flow-changing member 120 is lower than the counter force applied by the compression spring 115 thereon.

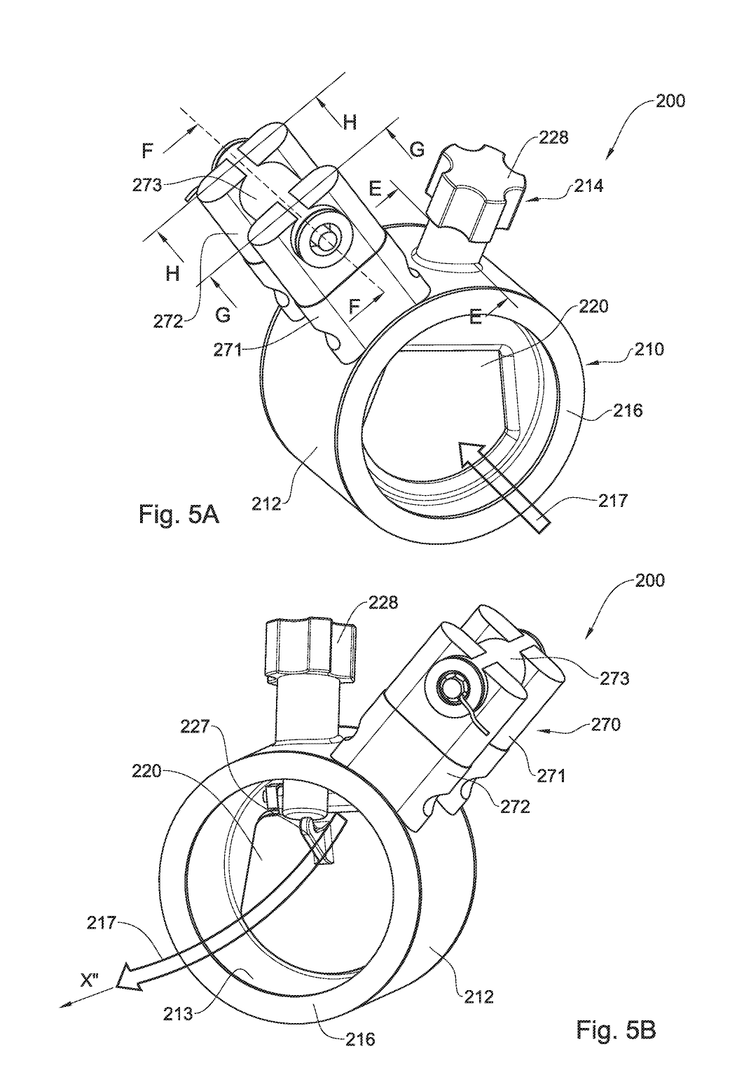

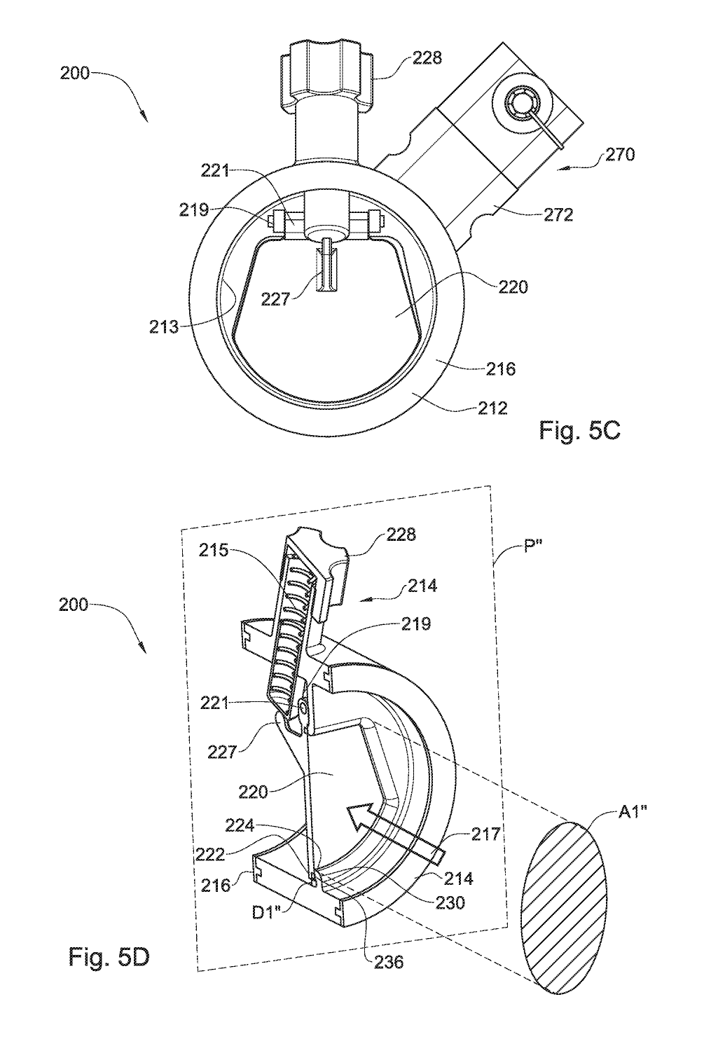

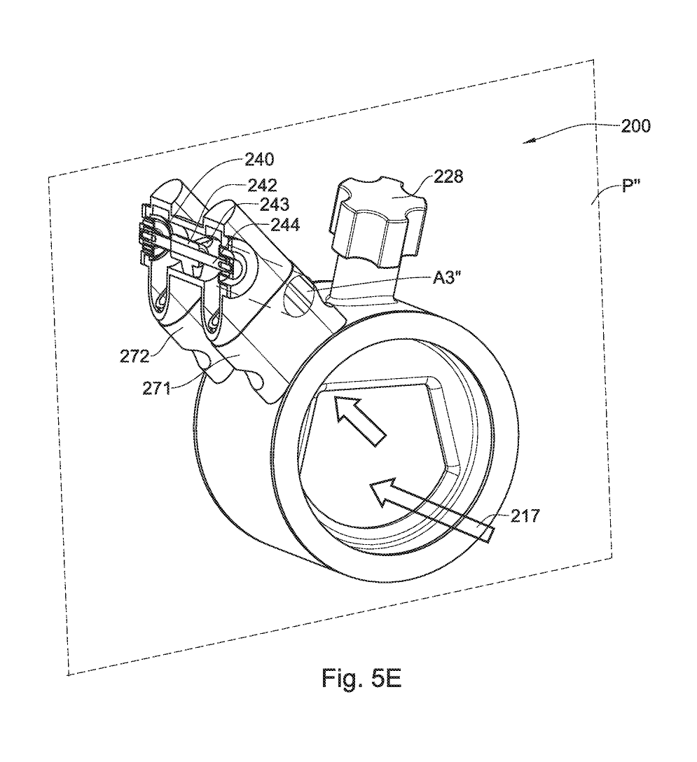

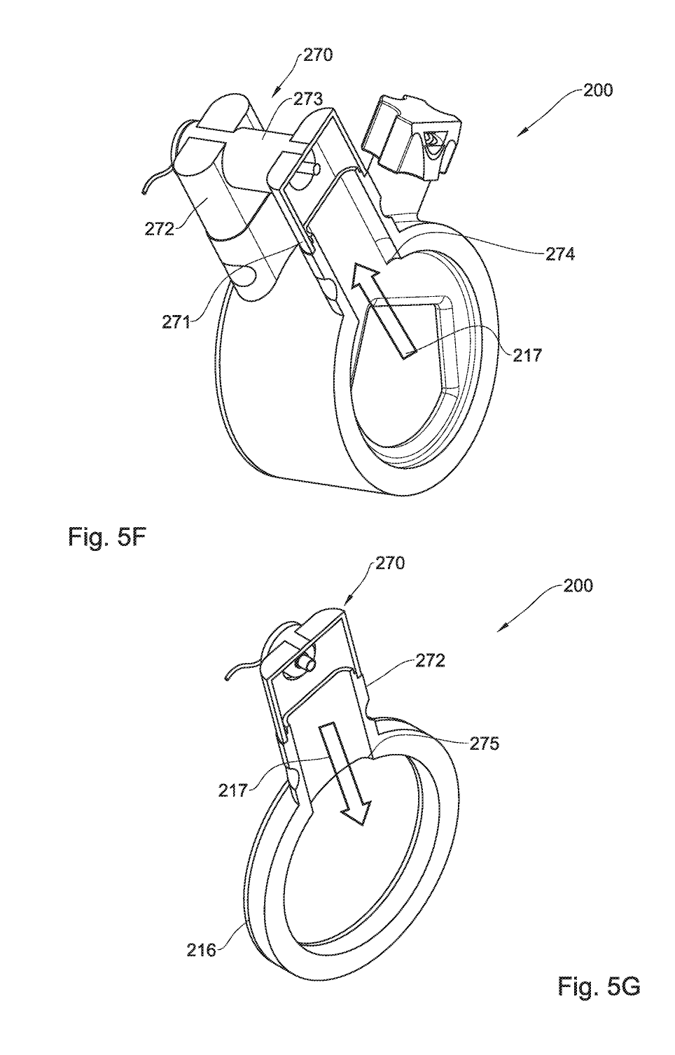

Attention is now directed to FIGS. 5A-G and 6A-E, illustrating an energy generating system 200 for transforming energy of fluid flow into electric energy, in accordance with a third example of the presently disclosed subject matter.

The system 200 has a fluid path 210 formed as a pipe having an elongate housing 212 with a path surface 213 extending between an inlet 214 and an outlet 216. The system 200 further has a fluid bypass 270 which is in fluid communication with the fluid path 210 and parallel thereto. The fluid bypass 270 is structured of a first portion 271, a second portion 272 and an intermediate portion 273 extending therebetween. The first portion 271 is in fluid communication with the fluid path 210 via a sub-inlet 274 (shown in FIG. 5F) formed on the path surface 213, and the second portion 272 is in fluid communication with the fluid path 210 via a sub-outlet 275 (shown in FIG. 5G) also formed on the path surface 213.

The system 200 is configured to be disposed in a fluid line (not shown) by connecting the inlet 214 and the outlet 216 to respective portions of the fluid line for allowing passage of fluid 217 therethrough in a flow direction X″.

In addition, the system 200 is configured with a flow-changing member 220 having a peripheral rim 222 (shown in FIG. 5D) and a turbine 240 integrated within the intermediate portion 273. The flow-changing member 220 is pivotally mounted to an interior portion 219 of the housing 212 by a pivot 221 and is surrounded by the path surface 213. The housing 212 is provided with a sealing portion 230 extending from the path surface 213 and disposed in proximity to the inlet 214. An internal surface 234 of the sealing portion 230 forms a passage for the fluid 217.

The turbine 240 has a rotor 242 with a plurality of vanes 243 rotatable on a shaft 244. The rotor 242 is rotatable within the turbine 240 when the fluid 217 passes therethrough, and respectively generates an electric energy.

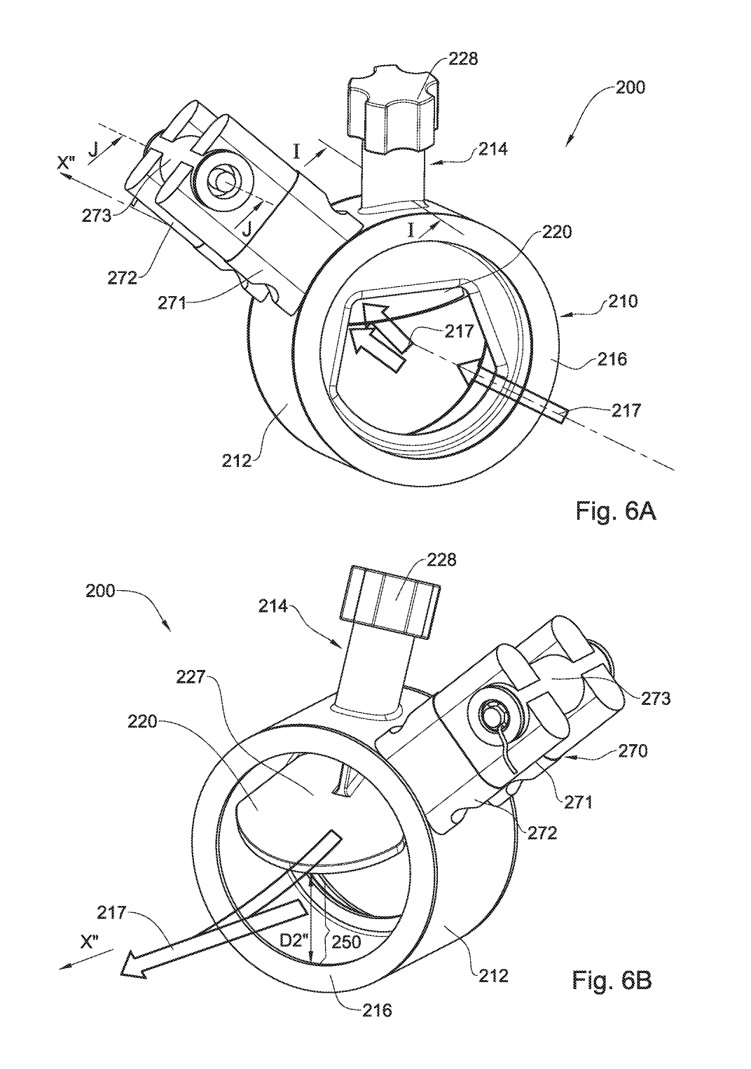

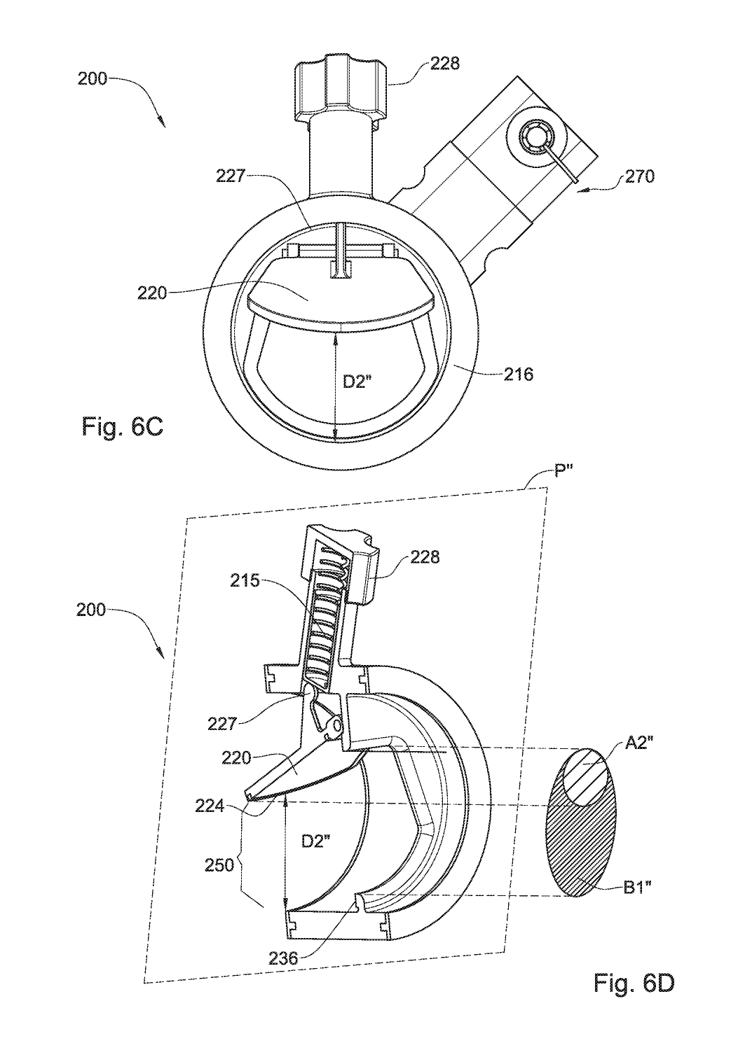

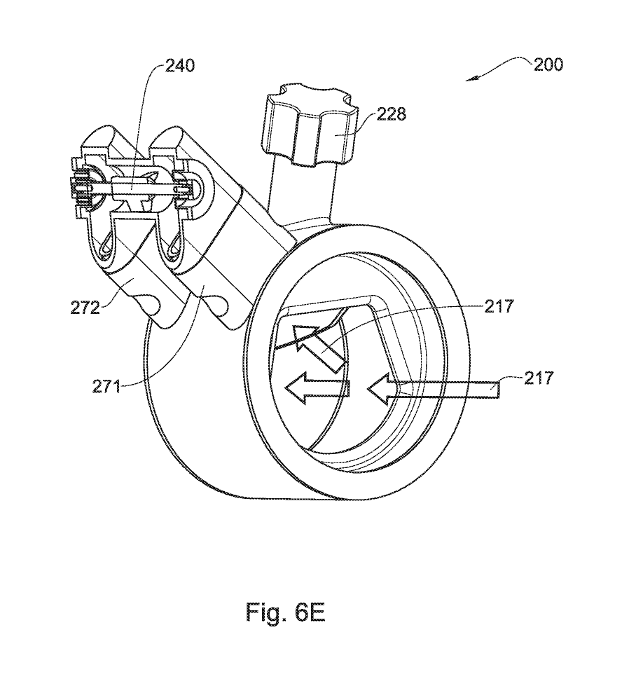

The flow-changing member 220 is displaceable between a first position shown in FIGS. 5A-G, in which the flow-changing member 220 is disposed perpendicularly to flow direction X″, and a second position shown in FIGS. 6A-E, in which the flow-changing member 220 is angled with respect to the flow direction X″. In the first and the second positions the turbine 240 is not displaced. Each one of these positions is explained in details below. It is appreciated that the second position shown in FIGS. 6A-E is only an example of such position, so that according to other examples of the second position, the angle between the flow-changing member 220 and the flow axis X″ can be much greater or smaller.

In the first position, as shown in FIG. 5D, the rim 222 is spaced from the path surface 213 to a first distance D1″. The system 200 has a reference plane P″ taken perpendicularly to the flow direction X″, so that in the first position, projection of the flow-changing member 220 on the reference plane P′ forms a first area A1″ (both shown in FIG. 5D). In addition, in the first position, projection of the turbine 240 on the reference plane P′ forms a third area A3″ (shown in FIG. 5E). In the first position, a sealing end 224 of the flow-changing member 220 is sealingly engaging a rear wall 236 of the sealing portion 230, so that the fluid 217 is able to pass only via the fluid bypass 270 and via the turbine 240. By that, the flow-changing member 220 causes the fluid 217 to be fully diverted into the fluid bypass 270, allowing maximally exploiting the flow energy of the fluid 217 for generation of electric energy by the turbine 240.

In the second position, the rim 222 is spaced from the path surface 213 to a second distance D2″, which is greater than the first distance D1″, forming a spacing 250 between the rim 222 and the path surface 213 for passage of the fluid 217 also therethrough (in addition to the turbine 240). In addition, in the second position, projection of the flow-changing member 220 on the reference plane P″ forms a second area A2″ (both shown in FIG. 6D). The second area A2″ is smaller than the first area A1″ by at least a first difference area B1″ formed outside the second area A2″. Since in the second position, the turbine 240 is not displaced, its projection on the reference plane P″ is not changed with respect to the third area A3″. In the second position, the sealing end 224 is disengaged from the rear wall 236 of the sealing portion 230, so that the fluid 217 is able to pass via the turbine 240 and via the spacing 250.

The fluid path 210 is further configured with a compression spring 215 engaging an extension member 227 of the flow-changing member 220 for urging the flow-changing member 220 to be in its normal first position.

When the total volumetric flow rate of the fluid 217 is below a predetermined threshold, the flow-changing member 220 is disposed in its first position. In this position, the force applied by the fluid 217 on the flow-changing member 220 is lower than the counter force applied on the extension member 227 by the compression spring 215, thereby preventing displacement of the flow-changing member 220 from the first position. This means that the predetermined threshold is determined by the compression spring 215. The compression spring 215 constitutes portion of a compression-regulating mechanism 214 configured for regulating compression of the compression spring 216 by regulating its length. This regulation is performed by rotating a regulator 228, and thereby determining said predetermined threshold.

However, when the total volumetric flow rate of the fluid 217 is increased above the predetermined threshold to an increased volumetric flow rate, the force applied by the fluid 217 on the flow-changing member 220 is greater than the counter force applied on the flow-changing member 220 by the compression spring 215, thereby pushing the flow-changing member 220 in the flow direction X″ and inducing its displacement toward the second position.

That displacement of the flow-changing member 220 causes the volumetric flow rate of the fluid 217 at the spacing 250 to be above the increased volumetric flow rate and the volumetric flow rate of the fluid 217 at the turbine 240 to be below the increased volumetric flow rate.

Such operation of the flow-changing member 220 is intended to protect the turbine 240 from overheating, or even burning out, when the total volumetric flow rate of fluid is increased above the predetermined threshold. As can be understood from the above explanation, when the flow-changing member 220 is disposed in its first position, it constitutes disturbance along the fluid path 210. However, when the total volumetric flow rate is increased above the predetermined threshold, flow-changing member 220 is displaced from its first position toward its second position, thereby forming therebetween spacing and at least the first difference area B1″. This displacement decreased the effective disturbance to passage of fluid between the flow-changing member 220 and the path surface 213, allowing part of the fluid to pass via the spacing 250 and at least the first difference area B1″, instead of through the turbine 240. By that, the turbine 240 is subject to less volumetric flow rate of the fluid passing therethrough, when compared to situation in which the flow-changing member 220 is not displaced from its first position.

In accordance with the above description, it is understood that when the total volumetric flow rate is decreased below the predetermined threshold, the flow-changing member 220 is displaced back to its first position. This displacement is performed by operation of the compression spring 215 on the flow-changing member 220, since the force applied by the fluid 217 on the flow-changing member 220 is lower than the counter force applied by the compression spring 215 thereon.

1-33. (canceled)

34. An energy generating system for transforming energy of fluid flow into electric energy, the system, at least in operation, comprising:
a flow-changing member having a peripheral rim and mounted in a fluid path having a path surface, so as to be at least partially surrounded by said path surface, said flow-changing member being displaceable between a first position, in which at least a portion of the rim is spaced from a corresponding portion of the path surface to a first extent and a second position, in which said portion of the rim is spaced from said portion of the fluid path surface to a second extent greater than said first extent, so that increase of total volumetric flow rate of said fluid above a predetermined threshold to an increased volumetric flow rate is configured to induce displacement of said flow-changing member from said first position toward said second position, thereby causing the volumetric flow rate of said fluid at said spacing to be above said increased volumetric flow rate; and
a turbine mounted in fluid communication with said fluid path at a location other than said spacing, whereby said displacement causes the volumetric flow rate of said fluid at said turbine to be below said increased volumetric flow rate.

35. The energy generating system of claim 34, wherein the flow-changing member is configured to be displaced from the first position to the second position by force of said fluid applied thereon.

36. The energy generating system of claim 34, wherein said flow-changing member is pivotally mounted to said path surface for pivotal displacement thereof from said first position toward said second position in a flow direction of said fluid.

37. The energy generating system of claim 36, wherein in said first position, said flow-changing member is configured to be disposed perpendicularly to flow direction of said fluid flowing at said path surface and in said second position, said flow-changing member is configured to be angled with respect to said flow direction.

38. The energy generating system of claim 34, wherein said path surface includes a socket for receiving said flow-changing member in said second position.

39. The energy generating system of claim 34, wherein the flow-changing member comprises a sealing end configured for sealingly engaging a sealing portion of said path surface in the first position of the flow-changing member, thereby preventing passage of fluid therebetween.

40. The energy generating system of claim 34, further comprising said fluid path; wherein said fluid path comprises a path inlet and a path outlet with said path surface extending therebetween.

41. The energy generating system of claim 40, further comprising an additional fluid path which is in fluid communication with said fluid path and in which said turbine is mounted.

42. The energy generating system of claim 41, wherein said additional fluid path is extending between a sub-inlet and a sub-outlet, both formed at said path surface so that the flow-changing member is mounted in the fluid path therebetween.

43. The energy generating system of claim 34, wherein said turbine is integrated in said flow-changing member and displaceable therewith between the first position and the second position.

44. An energy generating system for transforming energy of fluid flow into electric energy, the system comprising:
a flow-changing member having a peripheral rim and configured for being positioned in a fluid path having a flow direction and a path surface so as to be at least partially surrounded by said surface, said flow-changing member being displaceable between a first position, in which projection of the flow-changing member on a reference plane taken perpendicularly to said flow direction forms a first area, and a second position, in which projection of said flow-changing member on said reference plane forms a second area smaller than said first area by at least a first difference area formed outside said second area; and
a turbine configured to be mounted in fluid communication with said fluid path at a location other than said first difference area.

45. The energy generating system of claim 44, wherein the flow-changing member is configured to be displaced from the first position to the second position by force of said fluid applied thereon in said flow direction.

46. The energy generating system of claim 44, wherein said flow-changing member is pivotally mounted to said path surface for pivotal displacement thereof from said first position toward said second position in said flow direction.

47. The energy generating system of claim 44, wherein said path surface comprises a socket for receiving said flow-changing member in said second position.

48. The energy generating system of claim 44, wherein the flow-changing member includes a sealing end configured for sealingly engaging a sealing portion of said path surface in the first position of the flow-changing member, thereby preventing passage of fluid therebetween.

49. The energy generating system of claim 44, further comprising said fluid path; and wherein said fluid path comprises a path inlet and a path outlet with said path surface extending therebetween.

50. The energy generating system of claim 49, further comprising an additional fluid path which is in fluid communication with said fluid path and in which said turbine is mounted.

51. The energy generating system of claim 44, wherein said turbine is integrated in said flow-changing member and displaceable therewith between the first position and the second position.

52. A method for using an energy generating system for transforming energy of fluid flow into electric energy, the system, at least in operation, including: a flow-changing member having a peripheral rim and mounted in a fluid path having a path surface, so as to be at least partially surrounded by said path surface, said flow-changing member being displaceable between a first position, in which at least a portion of the rim is spaced from a corresponding portion of the path surface to a first extent and a second position, in which said portion of the rim is spaced from said portion of the fluid path surface to a second extent greater than said first extent; and a turbine mounted in said fluid path at a location other than said spacing, the method comprising:
experiencing increase of total volumetric flow rate of said fluid above a predetermined threshold to an increased volumetric flow rate; and
inducing displacement of said flow-changing member from said first position to said second position, thereby causing the volumetric flow rate of said fluid at said spacing to be above said increased volumetric flow rate and causing the volumetric flow rate of said fluid at said turbine to be below said increased volumetric flow rate.

53. The method of claim 52, wherein said step of inducing displacement is performed by virtue of force applied by said fluid on said flow-changing member.
